(19) United States
(12) Patent Application Publication
(10) Pub. No.: US 2003/0073433 A1
(43) Pub. Date: Apr. 17, 2003

(54) Mobile telecommunications device

(76) Inventor: Hossein Djelogiry, Fredensborg (DK)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/977,206

(22) Filed: Oct. 16, 2001

(51) Int. Cl. H04Q 7/20

(52) U.S. Cl. 455/426; 455/550

(57) ABSTRACT

WAP-enabled telephone handsets have been developed which allow the user to access remote servers. When using a search engine, a search term is prepared off-line and transmitted once the handset has established connection with the search engine server.

### FIELD OF THE INVENTION

The present invention relates to a mobile telecommunications device for accessing a server via a wireless telecommunications network.

### BACKGROUND

Conventional mobile telecommunications devices such as telephone handsets, have been designed primarily for speech calls and have only a limited capability for handling data. For example, in GSM, a short message service (SMS) has been provided to permit the user to send and receive short text messages that can be transmitted through a cellular public land mobile network (PLMN). More recently, recommendations have been developed to provide a wireless application protocol (WAP) to promote common standards and specifications for data services that operate over wireless communication networks. WAP-enabled telephone handsets have been developed which allow the user to access remote servers. Data content is provided in a mark up language, similar to conventional hyper text mark up language (HTML) known as a wireless mark up language (WML), which is configured to allow a page of HTML data to be displayed as a deck of individual cards which are of the size suited for display on the relatively small display screen usually available on a mobile device such as a cellular telephone handset or personal digital assistant (PDA).

The data is supplied by WML servers at individual network addresses, with a homepage which act as an entry point to a particular site together with further pages or decks with individual addresses that can be navigated by the user. To this end, the mobile device is provided with a browser to display the data.

A WML server can be accessed by dialling an individual telephone number associated with a WAP gateway which acts as a proxy server between the WML server itself and the mobile device, which acts as the client.

Newer, faster data services for mobile communication devices have been developed, including i-Mode, GPRS and UMTS which operate in a generally similar way, with the mobile device acting as client to remote servers, and a browser to display the accessed data on the mobile device. The browser that is used for mobile telecommunications devices is conventionally known as a microbrowser.

The mobile device, like any personal computer connected to the Internet, can access a large and growing number of pages available on the World Wide Web (WWW). Often, however, a user will be unaware of the existence or location of pages which may be of interest. To help locate such pages, a search engine can be used.

A search engine comprises a suite of programs which examine and catalogue pages available on the web and allow the user to search the catalogue using one or more search terms.

In general, the client transmits a search command to a server computer for the search engine. The search engine, running on the server or a computer system connected thereto, receives the search command and scans through the catalogue of pages, for example, searching for pages containing the, or each, search term. The results of the search are returned to the client and generally comprise a link to each page found, together with a summary.

The general procedure is no different where the client is a mobile handset, except that search commands and results pass through the gateway which performs protocol translations and data compression.

However, there is a drawback that a mobile handset must first establish a connection to the server computer before entering a search command. Only once a connection is established does the user enter and transmit their chosen search terms. Not only is this inconvenient for the user, but also it is expensive since the search is being conducted on-line.

The present invention seeks to overcome this problem.

### SUMMARY OF THE INVENTION

According to the present invention there is provided a mobile telecommunications device for accessing a server via a wireless telecommunications network, the device being configured to be provided with data by the user prior to establishing a connection with said server, said data comprising information for accessing said server and further information for use by said server, and said device being configured to transmit said further information to said server subsequent to establishing said connection.

Search engine software may be associated with said server, for example the search engine software may be run on said server.

The information for accessing said server may include a predefined link to said server and a command for selecting said predefined link.

The further information may comprise a request to be provided with a response from said server and the device may be configured to receive said response. The response may include a link for accessing a web page. The further information may comprise a search string for search engine software. The device may be configured to be provided with said data from said user prior to a session between said device and said server.

The device may be configured to provide a user interface for receiving said data from the user. The user interface may include a controller for processing said data from the user, keys for entering said data and a display for guiding said user when entering said data. The user interface may be configured to provide a menu comprising a plurality of selectable menu items. The first menu item may comprise a link for accessing a web page provided by said server. The second menu item may comprise an editor for entering information. The editor may be a text editor for entering a search string for search engine software.

The device may be WAP-enabled and may be a mobile telephone handset or a PDA.

According to the present invention there is also provided a method, in a mobile telecommunications device, of accessing a server via a wireless telecommunications network, the method comprising said device being provided with data from said user, said data comprising information for accessing said server and further information for use by said server, establishing a connection with said server and transmitting said further information to said server subsequent to establishing said connection.

### BRIEF DESCRIPTION OF THE DRAWINGS

An embodiment of the present invention will now be described, by way of example, with reference to the accompanying drawings in which:

FIG. 1 is a schematic block diagram illustrating a mobile telephone handset which can communicate through a public land mobile network (PLMN) and through a gateway to remote data servers;

FIG. 2 is a schematic block diagram of the circuitry of the mobile handset shown in FIG. 1;

FIG. 3 illustrates schematically the display of the handset and the associated keys 4;

FIG. 4 illustrates a procedure by which the mobile handset accesses a web page; and

FIGS. 5a and b illustrate a procedure by which the mobile handset prepares a search and accesses a search engine.

### DETAILED DESCRIPTION

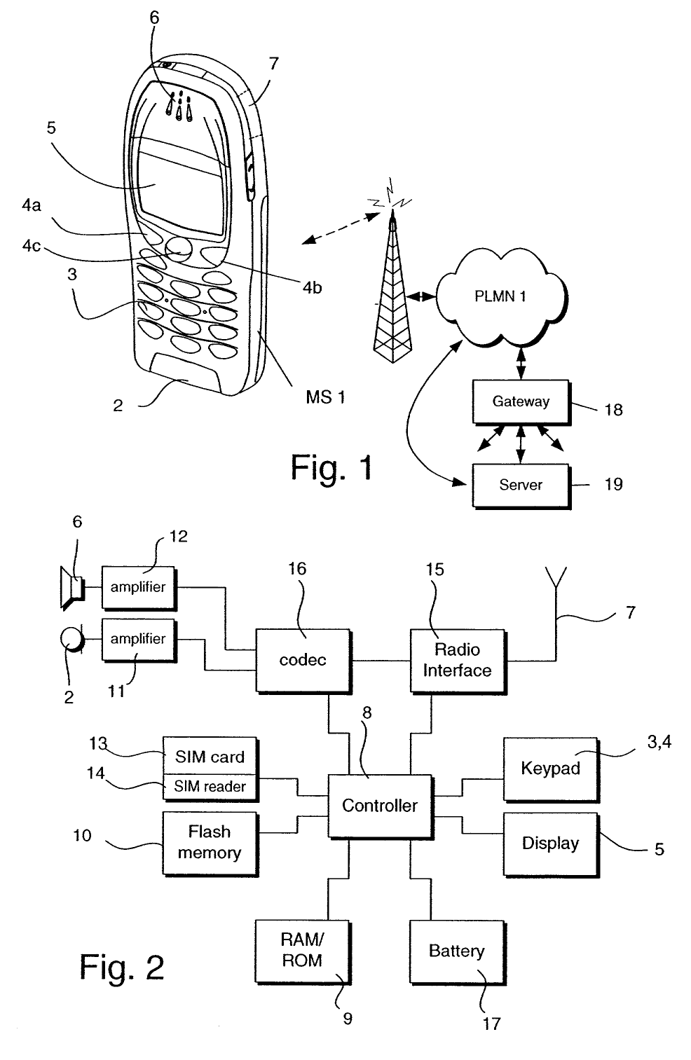

In FIG. 1, a mobile station in the form of a battery driven telephone cellular handset MS 1, is shown schematically in radio communication with PLMN 1. The mobile handset MS1, includes a microphone 2, keypad 3, soft keys 4, a liquid crystal display device 5, ear-piece 6 and internal antenna 7.

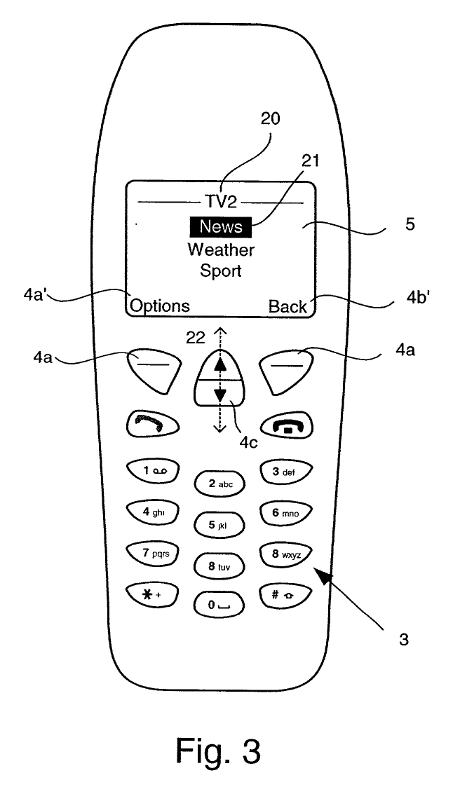

The circuitry of the handset MS 1 is shown in more detail in FIG. 2. Signal processing is carried out under the control of a digital micro-controller 8 which has an associated RAM/ROM 9 and flash memory 10. Electrical analogue audio signals are produced by microphone 2 and amplified by pre-amplifier 11. Similarly, analogue audio signals are fed to the ear-piece 6 through an amplifier 12. The micro-controller receives instruction signals from the keypad and so-called soft keys 4a,b,c, and controls operation of the LCD display 5.

Information concerning the identity of the user is held on a smart card 13 in the form of a GSM SIM card which contains the usual GSM international mobile subscriber identity and encryption K₁ that is used for encoding the radio transmission in a manner well known per se. The SIM card 13 is removably received in a SIM card holder 14. Radio signals are transmitted and received by means of the antenna 7 connected through a r.f. stage 15 to a codec 16 configured to process signals under the control of a micro-controller 8.

Thus, in use, for speech, the codec 16 receives analogue signals from the microphone amplifier 11, digitises them into a form suitable for transmission and feeds them to the rf stage 15 for transmission through antenna element 7 to PLMN 1 shown in FIG. 1. Similarly, signals received from PLMN 1 are fed through the antenna element to be demodulated by the r.f. stage 15 and fed to codec 16 so as to produce analogue signals fed to amplifier 12 and ear-piece 6.

Hardware, such as the microphone 2, keypad 3, soft keys 4, LCD 5, ear-piece 6 and micro-controller 8, and software, for example run by the micro-controller 8, provide a user interface through which the user can interact with the handset 1 for voice and data services. For example, keys, such as the keypad 3 and soft keys 4, are used to enter data and the LCD 5 is used to guide a user while entering data. The micro-controller 9 processes data provided by the user.

The mobile station MS1 is configured to operate as a client to receive data from remote servers and to communicate through PLMN 1 either to a gateway 18 shown in FIG. 1 which acts as a proxy server for connection to remote servers, such as server 19, or directly with the remote server. For example, for a WAP enabled system, access to the gateway 18 is provided by dialling a telephone number associated with the gateway although other communication techniques can be used e.g. for GPRS and UMTS. The server 19 may provide data corresponding to individual sites each with an individual homepage with a specific network address or universal resource locator (URL). The data may be provided in WML through the PLMN 1 to the handset MS1, which acts as a mobile client. Instead of using WML, the data may be provided in XHTML from the server 19, through the PLMN 1 to the handset MS1 without the need for a gateway 18. XHTML is a follow-on version to HTML 4.0.

The mobile handset MS1 runs a microbrowser. The software for running the microbrowser may be held in flash memory 10 shown in FIG. 2, so as to be run by the micro-controller 8 and provide an output on display 5.

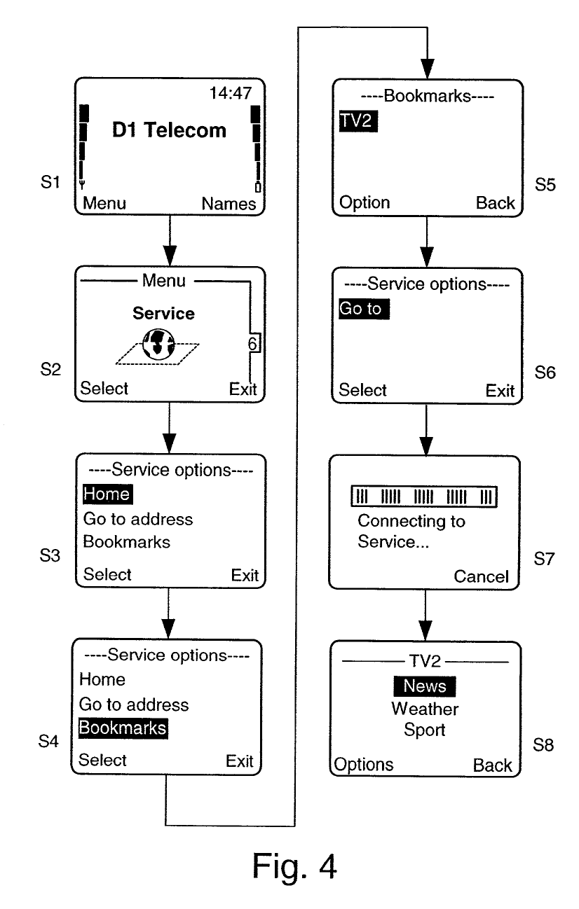

An example of the display provided by the microbrowser is shown in more detail in FIG. 3. In this example of the display 5, the user has accessed the homepage of a service provider TV2 as illustrated by information bar 20. A homepage for TV2 is shown with menu options “news”, “weather” and “sport”. These menu options comprise links to subsequent pages within the site, each with their own network address. The links may be selected using a so-called focus region 21 which can be scrolled upwardly and downwardly shown in FIG. 3 using key 4c, which can be pushed upwardly and downwardly in the direction of arrow 22 in order to perform a scrolling function. Thus, as shown in FIG. 3, the network address corresponding to “news” falls within the focus region 21.

Soft keys 4a and 4b are attributed functions shown on the display 5, which varies from display to display. For the homepage TV2 shown in FIG. 3, the keys 4a, 4b are attributed functions “options” and “back” respectively and appropriate legends 4a′ and 4b′ are displayed on the display 5 under the control of software being run by controller 8. If the key 4a is actuated, a list of options e.g. select, re-load, help etc are displayed (not shown) on the display 5. The “select” function may then chosen from the displayed list using the scrolling key 4c, in the event that the user wants to actuate the link to the “news” features shown on the homepage of FIG. 3. At this time, the soft key function attributed to the key 4a is itself “select” so that an operation of the key 4a will cause the link to the news page within the focus region 21 to be actuated and navigation to the “news” network address is carried out. Once the news page or deck is reached, the key 4b is attributed with function “back” and so actuation of the key 4b returns the user to the screen display shown in FIG. 3. Similarly, if the key 4b shown in FIG. 3 is actuated, the user will be returned to the screen display associated with the previously navigated network address, namely “news”. Thus, successive actuations of the soft key 4b, when attributed its “back” function causes the display to move back to the previous network address display. This may be made up of homepages for individual sites and pages cards or decks within individual sites. It will understood that typically during a data session, a user will go to a site, navigate through addresses within the site, then move to another site and perform similar operations. Thus, successive operations of the back key will call back the network addresses successively in a reverse sequence to that in which they were visited.

A procedure by which a page, in this example the TV 2 homepage, is accessed will now be described.

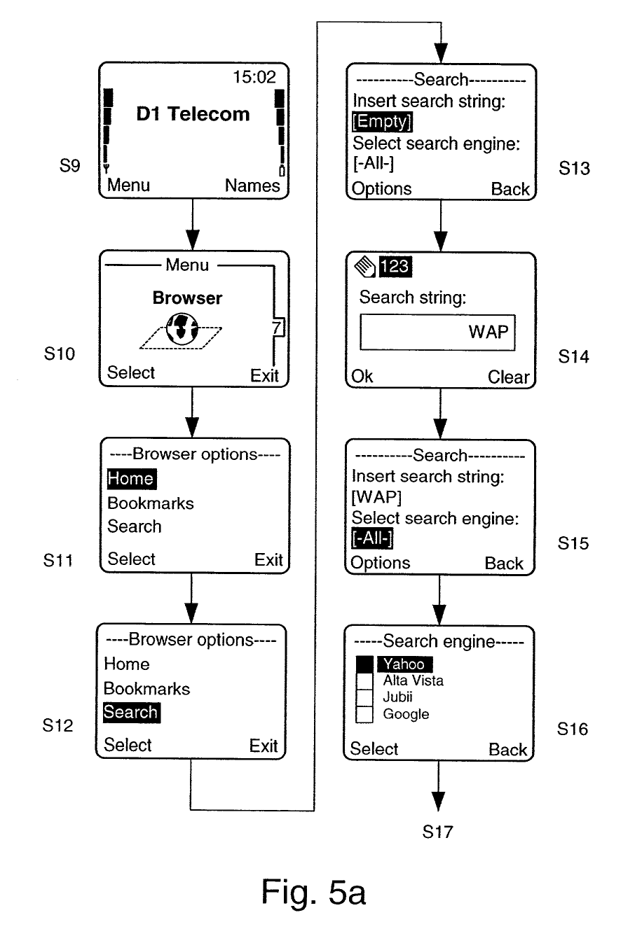

Referring to FIG. 4, the mobile handset MS1 is switched on and registered with a network operator “D1 Telecom”. The handset MS1 is ready to make and receive voice calls and use data services (step S1). The keys 4a, 4b are attributed functions “menu” and “names” respectively and appropriate legends 4a′ and 4b′ are displayed on the display 5 (FIG. 3). Actuation of key 4a accesses a menu of functions and services available to the user. The scrolling key 4c is repeatedly pressed until an entry for the “Service” is found (step S2). The user depresses key 4a (FIG. 3) to select and load the microbrowser.

The user is presented with a list of service options (step S3). The user scrolls through the list of service options until they find a “Bookmark” entry (step S4). The user operates key 3a to select the entry. Thereafter, they can choose a bookmark (step S5). Once done, the user initiates connection (step S6). The handset dials a number associated with the gateway 18 (FIG. 1) (step S7) and establishes a connection with to a TV2 remote server (not shown) via the gateway 18 (step S8).

In this way, the user can access similar pages and sites. In particular, the user can visit a site providing a search engine, such as Yahoo!™. Ordinarily the user accesses the site and enters further information on-line, i.e. a search term, which is transmitted to the server associated with the search engine and results are sent back to the handset MS1. However, this process has the drawback that is inconvenient and expensive in terms of money and airtime.

In accordance with the present invention, a procedure by which the device is provided with data by the user, the data comprising information for accessing a server, like a URL or a choice of bookmark, and also further information, in this case a search term, will now be described.

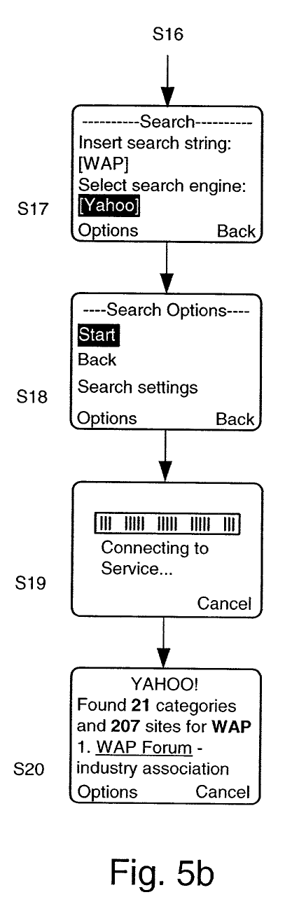

Referring to FIGS. 5a and b, the mobile handset MS1 is switched on and registered with a network operator “D1 Telecom” (step S9). The user accesses the menu of functions and services and operates the scrolling key 4c until an entry for “Browser” is found (step S10). The user depresses key 4a (FIG. 3) to select and load the microbrowser.

In this embodiment, further browser options are provided (step S11). The user scrolls through the list of browser options until they find a “Search” entry (step S12). The user operates key 3a to select the entry.

The user provides the device with data. The user enters the further information, in this case the search term, using the keypad 3 (FIG. 3) (steps S13 & S14). Thereafter, using the scroll and soft keys 4a, 4b, 4c, they select, from a list of predefined links, which search engine they wish to use (step S15 & 16). The user can select multiple engines. Thus, the device is provided with said data, including the search term, prior to a WAP session.

Once the search has been prepared (step S17), the user initiates a session by selecting “Start” (step S18). The handset MS1 dials a number associated with the gateway 18 (FIG. 1) (step S19) and establishes connection with a Yahoo!™ server (not shown) (step S20). The handset MS1 transmits the data including the further information, i.e. the search term, to the server. The search engine returns results to the handset in a conventional manner. The results are presented in the form of selectable hypertext items.

In this example, the further information comprises a request to be provided with information from the server, namely to be provided with search results. However, the handset MS1 can be used simply to supply information to the server, such a display or language preferences or details relating to the handset MS1.

It will be appreciated that many modifications may be made to the embodiment described above. For example, the search terms may be prepared off-line and sent to the server using short message service (SMS). The server can then return the results as a list of URLs. Alternatively, the server can return a URL for a page comprising the search results.

The invention is not restricted to the use of WAP technology but can be used in any mobile telecommunications system in which mobile devices act as clients for remote servers. Also, whilst the invention has been described in relation to the example of a telephone handset, it can be used in other mobile devices such as PDAs, gaming devices and remote handheld devices for home entertainment systems.

1. A mobile telecommunications device for accessing a server via a wireless telecommunications network, the device being configured to be provided with data by the user prior to establishing a connection with said server, said data comprising information for accessing said server and further information for use by said server, and said device being configured to transmit said further information to said server subsequent to establishing said connection.

2. A device according to claim 1, wherein search engine software is associated with said server.

3. A device according to claim 2, wherein said search engine software is run on said server.

4. A device according to claim 1, wherein said information for accessing said server includes a predefined link to said server.

5. A device according to claim 4, wherein said information for accessing said server includes a command selecting said predefined link.

6. A device according to claim 1, wherein said further information comprises a request to be provided with a response from said server.

7. A device according to claim 6, wherein the device is configured to receive said response.

8. A device according to claim 7, wherein said response includes a link for accessing a web page.

9. A device according to claim 1, wherein said further information comprises a search string for search engine software.

10. A device according to claim 1, wherein said device configured to be provided with said data from said user prior to a session between said device and said server.

11. A device according to claim 1, wherein the device is configured to provide a user interface for receiving said data from the user.

12. A device according to claim 11, wherein said user interface includes a controller for processing said data from the user.

13. A device according to claim 11, wherein said user interface includes keys for entering said data.

14. A device according to claim 11, wherein said user interface includes a display for guiding said user when entering said data.

15. A device according to claim 11, wherein said user interface is configured to provide a menu comprising a plurality of selectable menu items.

16. A device according to claim 15, wherein a first menu item comprises a link for accessing a web page.

17. A device according to claim 16, wherein a second menu item comprises an editor for entering information.

18. A device according to claim 17, wherein said editor is a text editor for entering a search string for search engine software.

19. A device according to claim 1, wherein said device is WAP-enabled.

20. A device according to claim 1 which is a mobile telephone handset.

21. A device according to claim 1 which is a PDA.

22. A method, in a mobile telecommunications device, of accessing a server via a wireless telecommunications network, the method comprising:
said device being provided with data from said user, said data comprising information for accessing said server and further information for use by said server;
establishing a connection with said server and
transmitting said further information to said server subsequent to establishing said connection.
